(19) United States
(12) Patent Application Publication
(10) Pub. No.: US 2016/0075194 A1
(43) Pub. Date: Mar. 17, 2016

(54) OPERATING HEAD FOR REMOVING AND FITTING WHEEL TYRES FOR VEHICLES

(71) Applicant: Giuliano Group S.p.A., Correggio (RE) (IT)

(72) Inventor: Maurizio BONACINI, Correggio (RE) (IT)

(21) Appl. No.: 14/848,433

(22) Filed: Sep. 9, 2015

(30) Foreign Application Priority Data
Sep. 12, 2014 (IT) MO2014A000256

(51) Int. Cl. B60C 25/05; B60C 25/138

(52) U.S. Cl. CPC B60C 25/056; B60C 25/138

(57) ABSTRACT

The operating head (1) for removing and fitting wheel tyres for vehicles, comprises a tool (8) for the fitting and/or removal of a tyre, associable with a tool-carrying arm (7) of a tyre-changing machine (2) and having an abutment portion (9) which can be positioned in correspondence of a stretch of the edge (B) of the rim (C) of a wheel (R) fixed on the tyre-changing machine (2), a force measuring device (11) linked together with the tool (8) and having a contact portion (12) arranged substantially in correspondence of the abutment portion (9) and able to be placed in contact with the edge (B) of the rim (C) to detect the force applied on the edge (B) along at least a direction of detection.

### RELATED APPLICATION

This application claims the benefit of priority of Italian Patent Application No. MO2014A000256 filed Sep. 12, 2014, the contents of which are incorporated herein by reference in their entirety.

### FIELD AND BACKGROUND OF THE INVENTION

The present invention relates to an operating head for removing and fitting wheel tyres for vehicles.

It is well known that vehicle wheels generally comprise a metal rim having along its perimeter annular flanges among which the end portions, so-called “beads”, of an elastic tyre are inserted in adhering abutment.

The use is currently known of machines, so-called “tyre-changing machines”, suitable for removing and fitting the tyre from/onto the relative rim to run, e.g., maintenance, repair or replacement jobs.

Different types of tyre-changing machines are known, in particular, comprising an operating head having a tool which can be shifted in height and horizontally by the action of respective actuators and usable for fitting and removing the tyre onto/from the rim.

The tools of known type generally have a lower abutment portion which can be positioned in correspondence of a stretch of the rim edge of a wheel fixed on the machine, in order to allow the tyre removal operations.

In addition, a particular type of known tools has a retractable nail with a curved end part able to grip the tyre bead.

In particular, the nail is movable, due to the action of an actuator commonly mounted on the movable arm, between a bead fastening position, wherein it extends from the operating head to be interposed between the annular flange of the rim and a stretch of the tyre to be removed, and an extraction position of the tyre edge, wherein it is raised to extract the stretch of the bead grasped above the rim annular flange.

During use, the operator adjusts the position of the operating head with respect to the frame according to the specific dimensions of the wheel, and positions the tool resting on the rim edge.

The nail is then brought to the fastening position and the end part presses the tyre flank as far as introducing itself between the tyre bead and the relative flange on the rim, so as to position the hooked extremity to retain the tyre bead. Subsequently, the nail is positioned in the extraction position so as to extract a portion of the bead above the rim.

The rotation of the rim then allows the coming out of the entyre bead from the respective flange.

The operating heads and tools of the known type generally have, however, some drawbacks.

In particular, the positioning of the lower portion of the tool on the rim edge is carried out manually by the operator who, according to his/her sensitivity, adjusts the force applied by the tool on the edge of the rim itself.

This implies therefore the need to use qualified personnel and, in any case, can result in damages to the rim during the positioning of the tool, or else subsequently, during the tyre removal job.

### SUMMARY OF THE INVENTION

The main aim of the present invention is to provide an operating head for removing and fitting wheel tyres for vehicles which allows to eliminate the risks of damaging the rim caused by an excessive pressure of the tool during the tyre fitting/removal operations.

Another object of the present invention is to provide an operating head for removing and fitting wheel tyres for vehicles which allows to overcome the mentioned drawbacks of the prior art within the ambit of a simple, rational, easy, effective to use and affordable solution.

The above mentioned objects are achieved by this operating head for removing and fitting wheel tyres for vehicles according to claim 1.

### BRIEF DESCRIPTION OF THE SEVERAL VIEWS OF THE DRAWINGS

Other characteristics and advantages of the present invention will become better evident from the description of a preferred, but not exclusive embodiment of an operating head for removing and fitting wheel tyres for vehicles, illustrated by way of an indicative but non-limiting example, in the accompanying drawings in which:

FIG. 1 is a view of the operating head according to the invention installed on a tyre-changing machine;

FIG. 2 is an axonometric view of the operating head according to the invention;

FIG. 3 is a side view illustrating the positioning of the operating head according to the invention in correspondence of a stretch of the rim edge of a wheel.

### DESCRIPTION OF SPECIFIC EMBODIMENTS OF THE INVENTION

With particular reference to such figures, reference number 1 globally indicates an operating head installable on a tyre-changing machine 2 and usable for the fitting and/or removal of a tyre P onto/from the rim C of a wheel R.

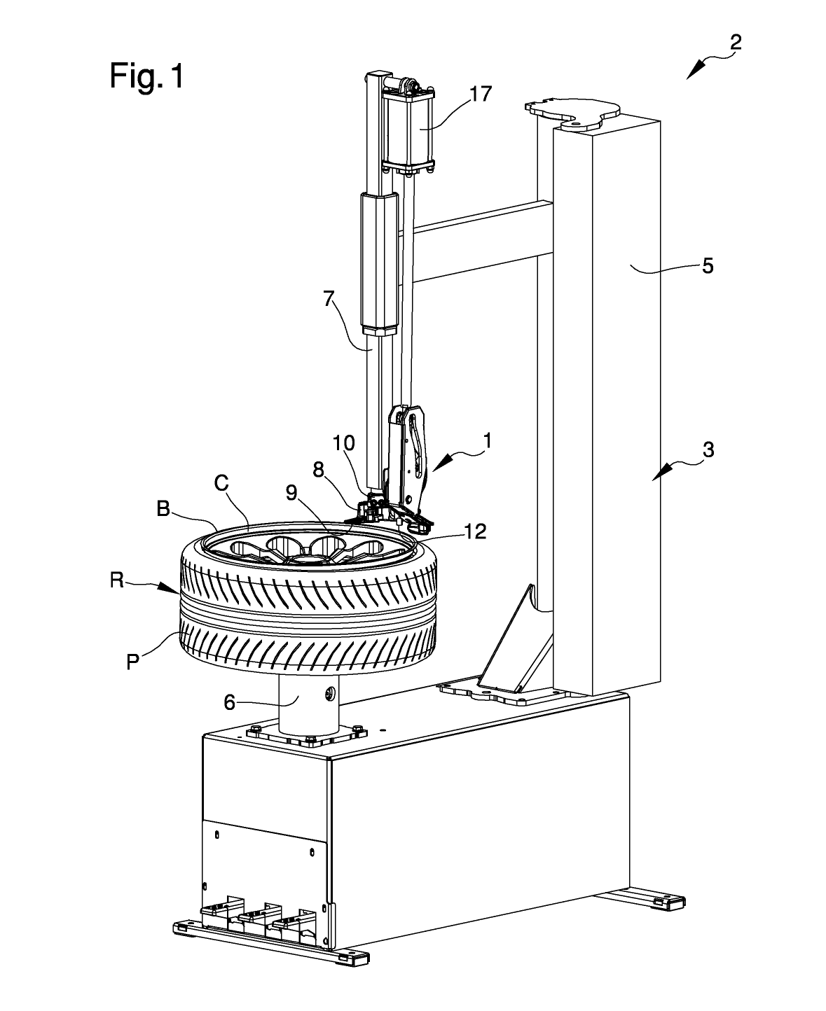

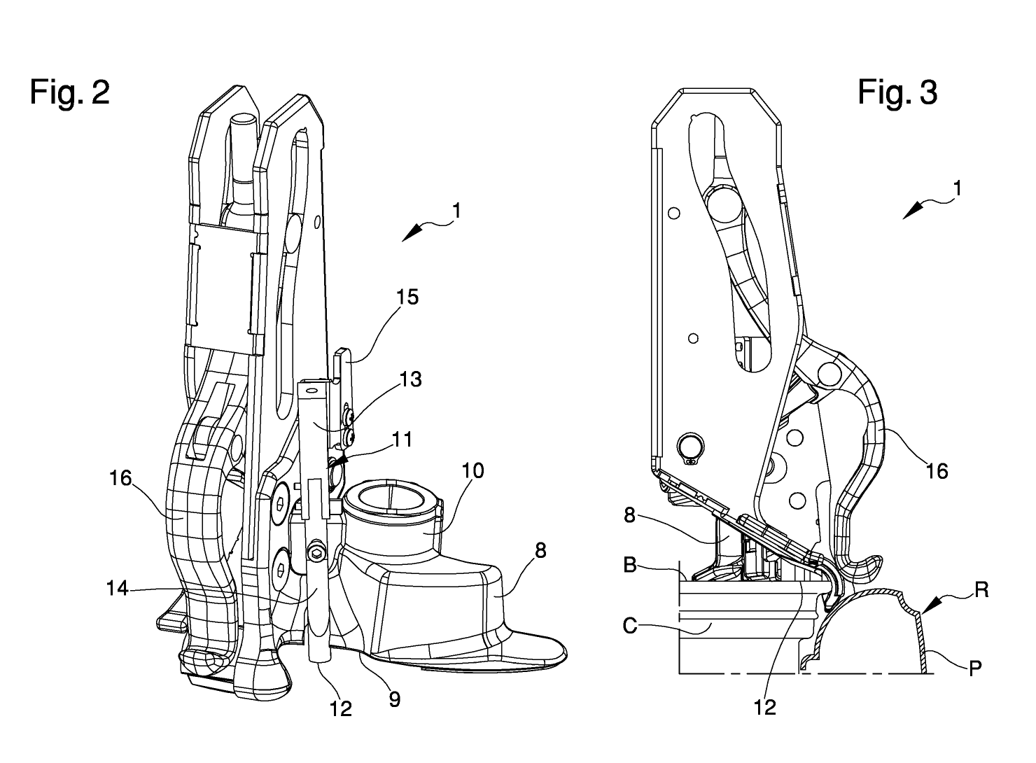

As illustrated by way of example in FIG. 1, the operating head 1 can be installed on a machine 2 for the removal and fitting of wheel tyres for vehicles of a conventional type.

For example, the machine 2 may comprise a bearing structure 3, substantially made up of a base 4 resting on the ground and of an upright 5 which rises from the base itself, locking means 6 of a rim C of a wheel R supported by the base B and a tool-carrying arm 7 supported movable vertically and horizontally to the upright 5.

In particular, the operating head 1 can be fixed to the lower extremity of the tool-carrying arm 7 of the machine 2.

The operating head 1 comprising at least a fitting/removing tool 8 associable with the tool-carrying arm 7 and having an abutment portion 9 which can be positioned in correspondence of a stretch of the edge B of the rim C of the wheel R.

In particular, the tool 8 has attachment means 10, the type of one or more threaded elements, able to allow the anchoring of the operating head 1 at the lower extremity of the tool-carrying arm 7.

Advantageously, the operating head 1 comprises a force measuring device 11 linked together with the tool 8 and having a contact portion 12 arranged substantially in correspondence of the abutment portion 9 and able to be placed in contact with the edge B of the rim C to detect the force applied on the edge B along a respective direction of detection.

In particular, the force measuring device 11 comprises a force sensor 13.

Preferably, the force sensor 13 is constituted by a load cell of the type, e.g., of a shear load cell or the like.

Preferably, the force measuring device 11 also comprises at least a feeler element 14 having the contact portion 12 and associated with the force sensor 13.

In particular, the feeler element 14 has a substantially elongated conformation, extends along a direction of detection and has an extremity associated with the force sensor 13 and an opposite extremity having the contact portion 12.

With reference to the particular embodiment illustrated in the figures, the force sensor 13 is anchored to the body of tool 8 by means of at least one holding bracket 15. A different fastening of the force sensor 13 to the tool 8 cannot however be ruled out.

Different embodiments of the force measuring device 11 cannot also be ruled out in which, e.g., the contact portion 12 is made up of a portion of the tool 8 and the force sensor 13 is integrated in the tool itself.

Advantageously, the operating head 1 may comprise a plurality of force sensors 13 having respective contact portions 12 able to engage in correspondence of respective portions of the edge B of the rim C, in order to detect the forces applied on the edge B along different directions of detection.

Furthermore, the machine 2 has movement means for moving the operating head 1 along a vertical direction, not shown in the illustrations, operatively connected to the force sensor 13 and able to vary the pressure of the contact portion 12 of the operating head 1 on the edge B of the rim C depending on the force detected by the force sensor 13.

Advantageously, said movement means are able to vary the position of the operating head 1 also during the removal or fitting operations of the tyre, depending on the force variations detected by the force sensor 13.

In this way it is possible to avoid any damage to the rim due to, e.g., variations in the inclination or the conformation of the surface of the edge B of the rim C. Still with reference to the particular embodiment illustrated in the figures, the operating head 1 comprises a movable nail 16 supported by the tool 8 and having a substantially hook-shaped free extremity.

The movable nail 16 is able to be moved by the action of actuator means 17 between a fastening position, wherein it extends from the tool 8 beyond the abutment portion 9 to be inserted between the edge B of the rim C and the tyre P and to position the free extremity below the bead of the tyre P, and an extraction position, wherein the free extremity is arranged in correspondence of the abutment portion 9 to extract the bead of the tyre P above the edge B of rim C.

It has in practice been ascertained how the described invention achieves the proposed objects.

In particular the fact is underlined that the presence of the force measuring device allows to eliminate the risks of damaging the rim caused by an excessive pressure by the tool during the tyre fitting/removal operations.

What is claimed is:

1. Operating head (1) for removing and fitting wheel tyres for vehicles, comprising at least a tool (8) for the fitting and/or removal of a tyre, associable with a tool-carrying arm (7) of a tyre-changing machine (2) and having at least an abutment portion (9) which can be positioned in correspondence of a stretch of the edge (B) of the rim (C) of a wheel (R) fixed on said tyre-changing machine (2), and at least a force measuring device (11) linked together with said tool (8) and having a contact portion (12) arranged substantially in correspondence of said abutment portion (9) and able to be placed in contact with said edge (B) of the rim (C) to detect the force applied on said edge (B) along at least a direction of detection.

2. Operating head (1) according to claim 1, wherein said force measuring device (11) comprises at least a force sensor (13).

3. Operating head (1) according to claim 2, wherein said force sensor (13) comprises at least a load cell (13).

4. Operating head (1) according to claim 1, wherein said force measuring device (11) comprises at least a feeler element (14) having said contact portion (12) and associated with said force sensor (13).

5. Operating head (1) according to claim 4, wherein said feeler element (14) has a substantially elongated conformation, extends substantially along said direction of detection and has an extremity associated with said force sensor (13) and an opposite extremity having said contact portion (12).

6. Operating head (1) according to claim 1, wherein said force measuring device (11) is anchored to said tool (8) by means of at least a holding bracket (15).

7. Operating head (1) according to claim 1, wherein said contact portion (12) is made of at least a portion of said tool (8).

8. Operating head (1) according to claim 1, comprising a plurality of said force measuring devices (11) having respective contact portions (12) able to be placed in contact with respective portions of said edge (B) of the rim (C) to detect the forces applied on said edge (B) along different directions of detection.

9. Operating head (1) according to claim 1, wherein said tool (8) comprises attachment means (10) associable with said tool-carrying arm (7) of the tyre-changing machine (2).

10. Operating head (1) according to claim 1, comprising at least a movable nail (16) having a substantially hook-shaped free extremity, associated with said tool (8) and movable between a fastening position, wherein said movable nail (16) extends beyond said abutment portion (9) to be inserted between said edge (B) of the rim (C) and the tyre (P) of said wheel (R) and to position said free extremity below the bead of said tyre (P), and an extraction position, wherein said free extremity is arranged in correspondence of said abutment portion (9) to extract said bead of the tyre (P) above said edge (B) of the rim (C).

11. Machine (2) for removing and fitting wheel tyres for vehicles, comprising at least a bearing structure (3), locking means (6) of a rim (C) of a wheel (R) for vehicles and at least a tool-carrying arm (7) associated movable with said bearing structure (3), wherein said tool-carrying arm (7) has at least an operating head (1) according to claim 1.

12. Machine (2) according to claim 11, comprising movement means for moving said operating head (1) operatively connected to said force measuring device (11) and able to vary the pressure of said contact portion (12) of the operating head (1) on said edge (B) of the rim (C) depending on the force detected by said force measuring device (11).
